(19) United States
(12) Patent Application Publication
(10) Pub. No.: US 2020/0231140 A1
(43) Pub. Date: Jul. 23, 2020

(54) Method and Control Unit for Operating a Hybrid Vehicle

(71) Applicant: ZF Friedrichshafen AG, Friedrichshafen (DE)

(72) Inventors: Frank Deprez, Mariabrunn (DE); Jens Kastens, Tettnang (DE)

(21) Appl. No.: 16/744,801

(22) Filed: Jan. 16, 2020

(30) Foreign Application Priority Data
Jan. 17, 2019 (DE) 10 2019 200 536.5

(51) Int. Cl. B60W 20/40; B60W 10/02; B60W 30/18; B60W 40/105

(52) U.S. Cl. CPC B60W 20/40; B60W 10/0235; B60W 2510/0642; B60W 40/105; B60W 30/18054

(57) ABSTRACT

A method for operating a hybrid vehicle includes monitoring, a rotational speed of an internal combustion engine (2) or a rotational speed of an electric machine (3) or a rotational speed of a transmission (4) or a rotational speed of a driven end (5) during travel with the internal combustion engine (2) running and the separating clutch (7) engaged in order to determine an increase in driving resistance. The method also includes, when the monitored rotational speed falls below or reaches a first limiting value, partially disengaging the separating clutch (7) toward a disengagement position in which a torque transmitted by the separating clutch (7) is adjusted such that an idling speed governor of the internal combustion engine (2) accelerates the rotational speed of the internal combustion engine toward the idling speed of the internal combustion engine (2).

### CROSS-REFERENCE TO RELATED APPLICATION

The present application is related and has right of priority to German Patent Application No. 10 2019 200 536.5 filed on Jan. 17, 2019, which is incorporated by reference in its entirety for all purposes.

### FIELD OF THE INVENTION

The invention relates generally to a method for operating a hybrid vehicle. Moreover, the invention relates generally to a control unit for carrying out the method.

### BACKGROUND

FIG. 1 shows a diagram of a drive train of a hybrid vehicle. A hybrid vehicle includes a prime mover 1, which includes an internal combustion engine 2 and an electric machine 3. Moreover, a hybrid vehicle includes a transmission 4, which is connected between the prime mover 1 and a driven end 5 of the hybrid vehicle. An electric accumulator 6 cooperates with the electric machine 3. When the electric machine 3 is operated as a motor, the electric accumulator 6 is discharged to a greater extent. When the electric machine 3 is operated as a generator, the electric accumulator 6 is charged to a greater extent. A separating clutch 7 is connected between the internal combustion engine 2 and the electric machine 3. The transmission 4 includes multiple shift elements 8. Only one single shift element 8 is shown, by way of example, in FIG. 1. During the starting operation of the hybrid vehicle, one of the shift elements 8 of the transmission 4 can act as a transmission-internal starting component. In contrast thereto, it is also possible that a separate, transmission-external starting component is connected between the electric machine 3 and the transmission 4.

The operation of the transmission 4 is controlled by a transmission control unit 9 by way of an open-loop system and/or a closed-loop system. The operation of the internal combustion engine 2 is controlled by an engine control unit 10 by way of an open-loop system and/or a closed-loop system. The operation of the electric machine 3 is controlled by a hybrid control unit 11 by way of an open-loop system and/or a closed-loop system. The hybrid control unit 11 can also control the separating clutch 7. The dashed-line double arrows from FIG. 1 visualize the data exchange of the control units 9, 10, and 11 with the appropriate assemblies of the hybrid vehicle. For example, the transmission control unit 9 exchanges data with the transmission 4 and the hybrid control unit 11. The engine control unit 10 exchanges data with the internal combustion engine 2 and the hybrid control unit 11. Moreover, the hybrid control unit 11 exchanges data with the electric machine 3, the electric accumulator 6, and the separating clutch 7.

It is known from practical experience that a rotational speed is monitored during travel with the internal combustion engine 2 running and, in fact, when the running internal combustion engine 2 is coupled, with the separating clutch 7 engaged, to the power flow toward the driven end 5, so that, for the case in which the monitored rotational speed falls below a limiting value, the internal combustion engine 2 is decoupled from the power flow, in particular in order to avoid stalling the internal combustion engine 2. The monitored rotational speed can be a rotational speed of the internal combustion engine 2, or a rotational speed of the electric machine 3, or a rotational speed of the driven end 5, or a rotational speed of the transmission 4, such as a rotational speed of a transmission input shaft of the transmission 4.

DE 10 2013 224 379 A2 discloses a method for operating a hybrid vehicle, in which, during the recuperation operation when the electric machine is operated as a generator, a coupling element connected between the internal combustion engine and the electric machine is actuated in such a way that the internal combustion engine is partially decoupled from the electric machine.

U.S. Pat. No. 8,386,107 B2 discloses a method for operating a hybrid vehicle, in which a deceleration of the hybrid vehicle is detected and a downshift is carried out in a transmission of the hybrid vehicle. Depending on the deceleration and the downshift, a standstill of the engine is predicted and, depending thereon, an engagement element is disengaged or brought into a state of slip.

DE 10 2018 207 122.5 describes that, for the case in which the monitored rotational speed falls below or reaches the first limiting value, the separating clutch connected between the internal combustion engine and the electric machine is completely disengaged in order to decouple the internal combustion engine.

### SUMMARY OF THE INVENTION

On the basis thereof, example aspects of the invention create a new method for operating a hybrid vehicle and a control unit for carrying out the method.

A method for operating a hybrid vehicle includes, for the case in which the monitored rotational speed falls below or reaches the first limiting value, partially disengaging the separating clutch connected between the internal combustion engine and the electric machine toward a disengagement position in which a torque transmitted by the separating clutch is adjusted in such a way that an idling speed governor or controller of the internal combustion engine nevertheless accelerates the rotational speed of the internal combustion engine toward the idling speed of the internal combustion engine.

The invention has the advantage that, due to the fact that the separating clutch is not disengaged completely, but rather only partially into the defined disengagement position, positive torque can be made available at the driven end via the internal combustion engine, and the electric machine can be unloaded due to the use of the available potential of the internal combustion engine. In this way, the hybrid vehicle can be operated more efficiently. In addition, for the case in which the electric machine can provide only a small amount of torque or no more torque at all, for example, due to an electric accumulator having already been considerably discharged, torque can be made available at the driven end via the internal combustion engine.

According to one advantageous example refinement, the disengagement position of the separating clutch is determined depending on a presently maximally possible idling torque of the internal combustion engine, in particular, as a pilot control component for the disengagement position of the separating clutch. Preferably, this disengagement position of the separating clutch continues to be determined depending on an idling torque of the internal combustion engine presently demanded by the idling speed governor of the internal combustion engine or depending on a maximally permitted idling torque of the idling speed governor, in such a way that torque transmitted by the separating clutch in the disengagement position corresponds to the difference between the maximally possible idling torque and the idling torque presently demanded by the idling speed governor of the internal combustion engine, in particular minus an offset or the difference between the maximally possible idling torque and the maximally permitted idling torque of the idling speed governor, in particular minus an offset.

In this way, the disengagement position of the separating clutch, toward which the separating clutch is disengaged, can be particularly advantageously determined within the scope of a pilot control component. On the one hand, the torque transmitted due to the selected disengagement position of the separating clutch is low enough that the idling speed governor of the internal combustion engine is capable of accelerating the internal combustion engine toward the idling speed. On the other hand, the torque potential of the internal combustion engine is utilized for assisting or unloading the electric machine.

According to an advantageous refinement, a governor component is superimposed on the pilot control component, which is determined depending on the developing actual rotational speed of the internal combustion engine and the idling speed of the internal combustion engine. For the case in which the governor component is superimposed on the pilot control component, the hybrid vehicle can be operated more efficiently.

### BRIEF DESCRIPTION OF THE DRAWINGS

Preferred refinements result from the following description. Exemplary embodiments of the invention are explained in greater detail with reference to the drawings, without being limited thereto. Wherein:

FIG. 1 shows a block diagram of a hybrid vehicle;

FIG. 2 shows a timing diagram for illustrating a method for operating a hybrid vehicle;

FIG. 3 shows a timing diagram for illustrating the method according to the invention for operating a hybrid vehicle;

FIG. 4 shows a further timing diagram for illustrating the method according to the invention for operating a hybrid vehicle.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

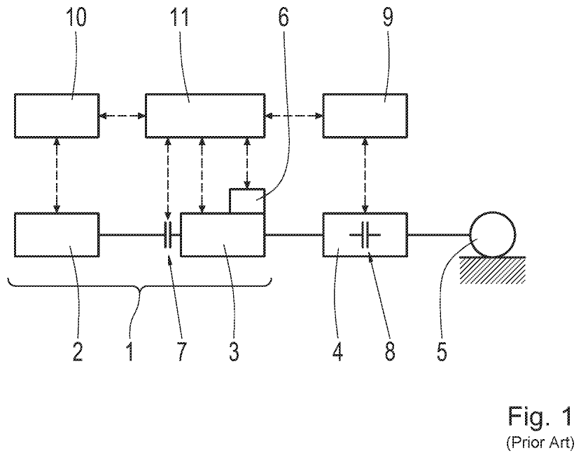

The invention relates to a method and to a control unit for operating a hybrid vehicle. The fundamental configuration of a hybrid vehicle is known to a person skilled in the art, who is addressed herein, and has been described above with reference to FIG. 1. In this regard, reference is made to the description of FIG. 1.

Example aspects of the present invention relate to details for operating a hybrid vehicle, with the aid of which the internal combustion engine 2 can be effectively protected against stalling and, in fact, without the risk of the torque failing at the driven end 5 and, therefore, the hybrid vehicle undesirably rolling backward, for the case in which the hybrid vehicle travels, for example, on an uphill grade or against an obstacle, i.e., the driving resistance increases, during travel with the internal combustion engine 2 running and the separating clutch 7 engaged.

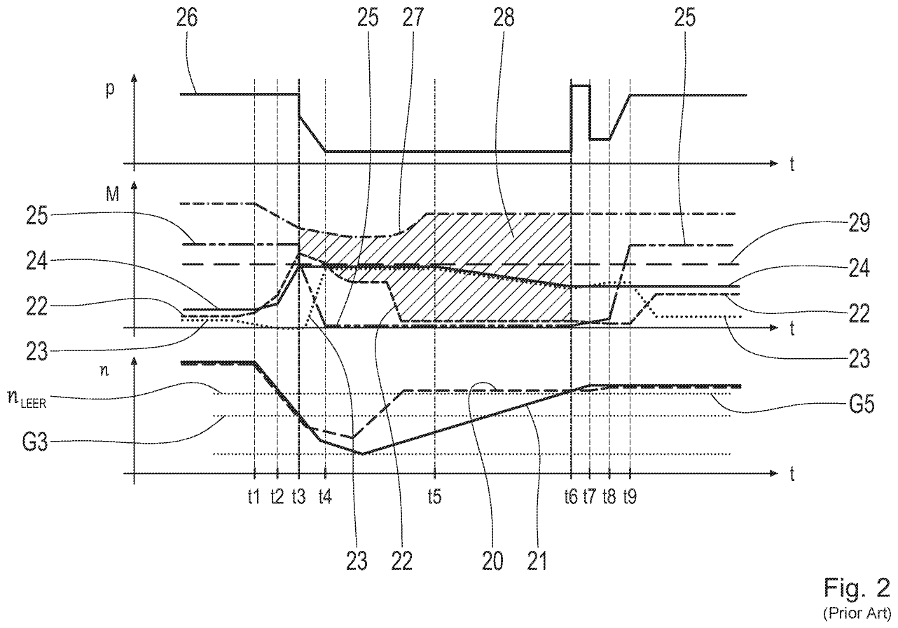

FIG. 2 shows details of a method for operating a hybrid vehicle, which is described in DE 10 2018 207 122.5.

In FIG. 2, multiple time profiles of rotational speeds n, torques M, and a pressure control p are shown with respect to the time t. The curve profile 20 from FIG. 2 shows a time profile of the rotational speed of the internal combustion engine 2. The curve profile 21 shows the time profile of a rotational speed of the electric machine 3. The curve profile 22 shows the time profile of a torque of the internal combustion engine 2. The curve profile 23 shows the time profile of a torque of the electric machine 3. The curve profile 24 shows the time profile of the torque at the driven end 5. A curve profile 25 visualizes a time profile of a torque transmitted by the separating clutch 7. The curve profile 26 visualizes the pressure control of the separating clutch 7.

Before the point in time t1, the hybrid vehicle travels with the internal combustion engine 2 running and with the electric machine 3 running and operating as a motor, and with the separating clutch 7 engaged. Beginning at the point in time t1, the rotational speed 20 of the internal combustion engine 2 and the rotational speed 21 of the electric machine 3 decrease due to the fact that the driving resistance of the hybrid vehicle increases while the gas pedal is actuated and the brake pedal is not actuated, for example, due to the onset of an uphill grade. Beginning at the point in time t2, the rotational speed 20 of the internal combustion engine 2 and the rotational speed of the electric machine 3 fall below the idling speed n_{LEER}.

The method is preferably carried out while the gas pedal is actuated and the brake pedal is not actuated. The method can also be carried out for the case in which, if the gas pedal is not actuated during a crawling operation, the driving resistance increases, for example, due to the onset of an uphill grade. During a crawling operation, the brake pedal can be unactuated or slightly actuated.

In FIG. 2, the rotational speed 21 of the electric machine 3 is subsequently monitored. Another rotational speed can also be monitored, for example, the rotational speed 20 of the internal combustion engine 2 or of a transmission input shaft of the transmission 4.

For the case in which, at the point in time t3, the monitored rotational speed falls below a first limiting value G3 with the internal combustion engine 2 running, with the electric machine 3 running and, with the separating clutch 7 engaged, while the gas pedal is actuated and the brake pedal is not actuated, the separating clutch 7 connected between the internal combustion engine 2 and the electric machine 3 is actuated in order to be disengaged, according to the curve profile 26, in order to thereby decouple the internal combustion engine 2 from the power flow to the driven end 5. As a result, the internal combustion engine 2 can be protected against stalling. Torque can still be provided at the driven end 5 with the aid of the electric machine 3, in order to thereby avoid a safety-critical situation, in particular, in which the motor vehicle undesirably rolls backward on an incline. The first limiting value G3 of the monitored rotational speed, upon the attainment or falling below of which, the separating clutch 7 is actuated in order to be disengaged, is preferably determined depending on a gradient with respect to time, according to which the monitored rotational speed decreases. This first limiting value G3 can also be determined, additionally or alternatively, depending on a temperature, in particular a temperature of the separating clutch 7 or a transmission oil temperature, and/or depending on the state of charge of the electric accumulator 6. As is apparent from FIG. 2, at the point in time t3, according to the pressure control 26, the power transmission capacity of the separating clutch 7 is initially abruptly reduced and, in fact, to a value which is just sufficient for transmitting the torque presently transmitted by the separating clutch 7. The abrupt reduction of the power transmission capacity of the separating clutch 7 at the point in time t3 therefore abruptly reduces an excess contact pressure of the separating clutch 7.

Subsequent to the point in time t3, between the points in time t3 and t4, the power transmission capacity of the separating clutch 7 to be disengaged is further decreased in a ramp-like manner or linearly and, in fact, with a gradient, wherein this gradient with respect to time for the ramp-like reduction of the power transmission capacity of the separating clutch 7—as well as the limiting value G3—is preferably dependent on the gradient with respect to time of the reduction of the monitored rotational speed and/or on the temperature and/or on the state of charge of the electric accumulator 6.

At the point in time t4, the separating clutch 7 no longer transmits any torque. The rotational speed 20 of the internal combustion engine 2 can stop decreasing and can be increased, with the aid of the torque 22 of the internal combustion engine 2, to the level of the idling speed n_{LEER}.

Beginning at the point in time t5, according to the curve profile 24, the torque at the driven end 5 is reduced, for example, due to the fact that the speed of the vehicle is greater than a limiting value. The reduction of the torque at the driven end 5 takes place by reducing the torque made available by the electric machine 3 (see curve profile 23).

For the case in which, subsequent to the disengagement of the separating clutch 7, both the rotational speed of the internal combustion engine 2 as well as the rotational speed of the electric machine 3 exceed a second limiting value G5, which is greater than the first limiting value G3, the separating clutch 7 is engaged again. In FIG. 2, the second limiting value G5 corresponds to the idling speed n_{LEER}. In FIG. 2, the rotational speed 20 of the internal combustion engine 2 and the rotational speed 21 of the electric machine 3 reach the idling speed n_{LEER} at the point in time t6, wherein the previously disengaged separating clutch 7 is then actuated in order to be engaged, according to the pressure control 26, and, in fact, according to FIG. 2, initially via a rapid charging between the points in time t6 and t7, via a subsequent filling equalization phase between the points in time t7 and t8, and via a subsequent ramping up of the actuating pressure 26 for the separating clutch 7 between points in time t8 and t9, so that, at the point in time t9, the separating clutch 7 is completely engaged once again and the internal combustion engine 2 is once again coupled to the power flow toward the driven end 5.

As is apparent from the curve profile 24 from FIG. 2, even though the internal combustion engine 2 has been decoupled from the power flow, torque can be provided at the driven end 5 with the aid of the electric machine 3. There is no risk of the hybrid vehicle undesirably rolling backward.

In FIG. 2, a further curve profile 27 with respect to time visualizes a presently maximally possible idling torque of the internal combustion engine 2. Due to the fact that, in FIG. 2, the separating clutch 7 is completely disengaged up to the point in time t4 and remains completely disengaged up to the point in time t6, so that the separating clutch 7 can initially transmit only a reduced torque between the points in time t3 and t4 and, subsequently, between the points in time t4 and t6, cannot transmit any more torque, an actually available torque potential of the internal combustion engine 2 can no longer be utilized, wherein the unused potential of the internal combustion engine 2 is visualized in FIG. 2 with the aid of the shaded area 28, which extends between the curve profile 22 and the curve profile 27 between the points in time t3 and t6.

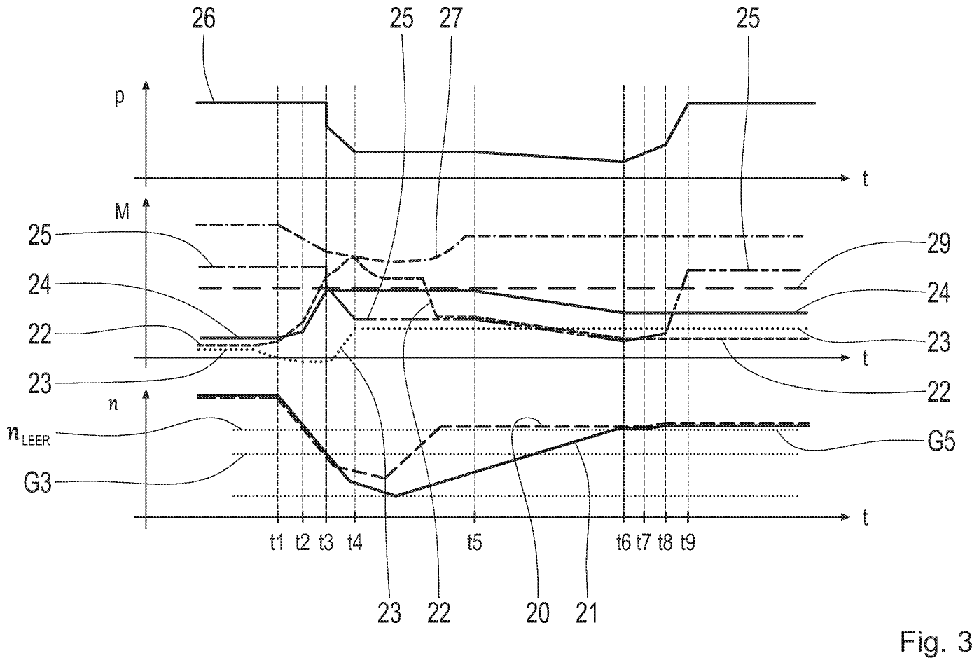

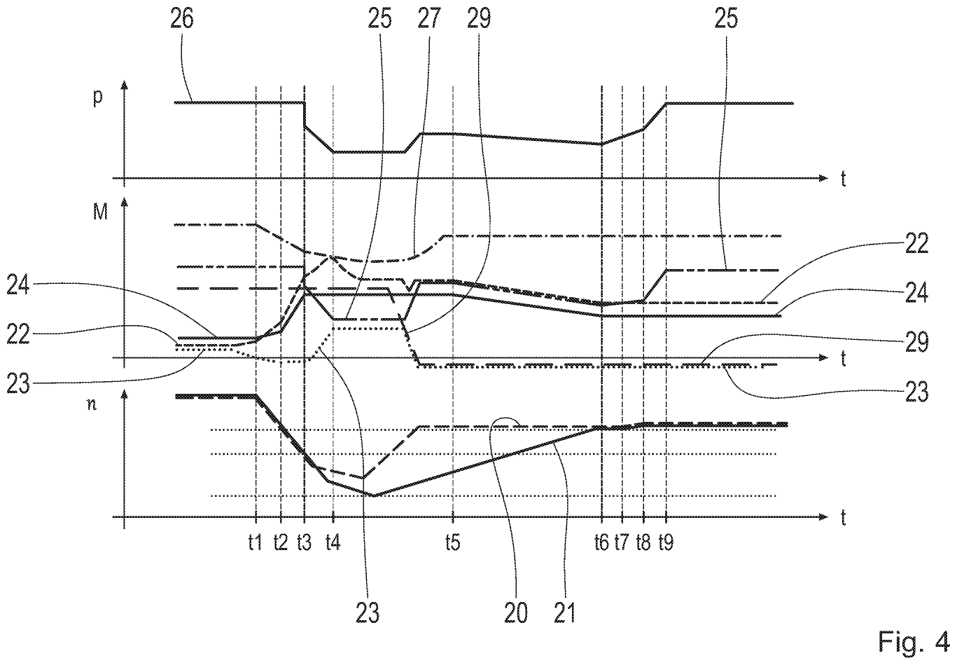

With the aid of example aspects of the present invention, this potential 28 of the internal combustion engine 2 is to be made usable, to the greatest extent possible, at the driven end 5. Details of example aspects of the invention in this regard are described in the following with reference to the time diagrams from FIGS. 3 and 4, wherein identical reference characters are utilized in the following for identical curve profiles and only such details are dealt with, on the basis of which the invention from FIG. 2 visualized in FIGS. 3 and 4 differs.

With the aid of example aspects of the present invention, it is provided that, for the case in which the monitored rotational speed falls below or reaches the first limiting value G3, the separating clutch 7 connected between the internal combustion engine 2 and the electric machine 3 is subsequently not completely disengaged, but rather only partially disengaged toward a defined disengagement position in which a torque transmitted by the separating clutch 7 toward the driven end is adjusted in such a way that an idling speed governor of the internal combustion engine 2 can accelerate the rotational speed of the internal combustion engine 2 toward the idling speed of the internal combustion engine 2.

It is apparent from FIG. 3 that, in FIG. 3, similarly to FIG. 2, beginning at the point in time t3, according to the pressure control 26, the separating clutch 7 is initially disengaged in a stepped manner or abruptly by a defined amount and, thereafter, between the points in time t3 and t4, is disengaged in a ramp-like manner, although not up to a disengagement position as in FIG. 2, in which the separating clutch 7 no longer transmits any torque, but rather up to a disengagement position in which, according to the signal curve 25, the separating clutch 7 continues to transmit torque toward the driven end 5. The disengagement position for the separating clutch 7 is selected in such a way that, on the one hand, the torque transmitted by the separating clutch 7 toward the driven end 5 is low enough that the idling speed governor of the internal combustion engine 2 is capable of accelerating the internal combustion engine 2 upward toward the idling speed of the internal combustion engine 2 or holding the internal combustion engine 2 at the idling speed and, on the other hand, a potential of the idling speed governor, which is presently not utilized for holding the rotational speed of the internal combustion engine 2 at the idling speed or bringing the internal combustion engine 2 up to the idling speed, is transmitted via the separating clutch 7 toward the driven end 5 in order to assist or unload the electric machine 3, in particular when the driver demand is made available or in response to driver demand. FIG. 3 shows that, according to the curve profile 22, the torque of the internal combustion engine 2 is raised as compared to FIG. 2 and, in fact, up to the presently maximally possible idling torque visualized with the aid of the curve profile 27, wherein, according to the curve profile 23, the torque made available by the electric machine 3 can be reduced and, therefore, in contrast to FIG. 2, it is not necessary to raise the torque 23 of the electric machine 3 to a maximally possible torque 29 of the electric machine 3. The electric machine 3 is unloaded.

In FIG. 3, similarly to FIG. 2, beginning at the point in time t5, the torque at the driven end 5 (see curve profile 24) is reduced, in particular triggered due to the fact that a speed of the vehicle is greater than a limiting value, wherein, then, in FIG. 3, the reduction of the torque made available at the driven end 5 (see curve profile 24) between the points in time t5 and t6, in contrast to FIG. 2, does not take place via a reduction of the torque of the electric machine 3, but rather due to a greater disengagement of the separating clutch 7 due to the reduction of the pressure control 26 of the separating clutch 7 between the points in time t5 and t6.

The disengagement position of the separating clutch 7, toward which the separating clutch 7 is disengaged within the meaning of the invention, and, in fact, in FIG. 3, up to the point in time t4, is preferably determined depending on the presently maximally possible idling torque 27 of the internal combustion engine 2, wherein, depending on the presently maximally possible idling torque 27 of the internal combustion engine 2, a pilot control component is determined for the disengagement position of the separating clutch 7.

According to a first example variant, it can be provided that this disengagement position of the separating clutch 7 is determined depending not only on the presently maximally possible idling torque 27 of the internal combustion engine 2, but rather additionally depending on an idling torque of the internal combustion engine 2 presently demanded by the idling speed governor of the internal combustion engine 2 and, in fact, in such a way that the torque transmitted by the separating clutch 7 in this disengagement position corresponds to the difference between the maximally possible idling torque 27 of the internal combustion engine 2 and the idling torque presently demanded by the idling speed governor of the internal combustion engine 2, preferably minus an offset.

Alternatively, it is possible to determine the disengagement position of the separating clutch 7, on the one hand, depending on the presently maximally possible idling torque 27 of the internal combustion engine 2 and, on the other hand, depending on a maximally permitted idling torque of the idling speed governor of the internal combustion engine 2 and, in fact, in such a way that the torque transmitted by the separating clutch 7 in the disengagement position corresponds to the difference between the maximally possible idling torque 27 of the internal combustion engine 2 and the maximally permitted idling torque of the idling speed governor of the internal combustion engine 2, preferably minus an offset.

The offset can be determined, for example, depending on a temperature-dependent drag torque of the separating clutch 7. If the temperature of the transmission is low, for example, the separating clutch 7 has a high drag torque. The higher the drag torque of the separating clutch 7 is, the greater the offset is.

The higher the drag torque of the separating clutch 7 is, the lower the amount of torque is that the separating clutch 7 can transmit toward the driven end 7 for a safe operation of the hybrid vehicle. In the case of a very high drag torque of the separating clutch 7, it can be necessary to completely disengage the separating clutch 7 and, in fact, similarly to FIG. 2.

According to one advantageous example refinement of the invention, it is provided to superimpose a governor component on the pilot control component for the disengagement position of the separating clutch 7. This governor component is preferably determined depending on a developing actual rotational speed of the internal combustion engine 2 and on the idling speed of the internal combustion engine 2.

If the idling speed governor cannot accelerate the actual rotational speed of the internal combustion engine 2 with a desired gradient toward the idling speed, the power transmission capacity of the separating clutch 7 must be reduced and the separating clutch 7 must be disengaged to a further extent.

However, if the gradient of the rotational speed of the internal combustion engine, with which the internal combustion engine is accelerated toward the idling speed, is relatively steep, the separating clutch 7 may possibly be engaged to a greater extent or disengaged to a lesser extent in order to transmit more torque toward the driven end 5 and to further unload the electric machine 3.

Due to the fact that, additionally, the governor component is superimposed on the pilot control component, the hybrid vehicle can be operated more efficiently.

FIG. 4 shows a modification of the curve profiles from FIG. 3, in which, between the points in time t4 and t5 according to the curve profile 29, a maximally possible torque of the electric machine 3 is reduced, in particular triggered due to the fact that a state of charge of an electric accumulator falls below a limiting value and/or the electric accumulator becomes too hot and/or a power electronics unit, which cooperates with the electric accumulator or the electric machine 3, reaches or exceeds a limiting value.

Accordingly, in FIG. 4, due to the reduction of the maximally possible torque 29 of the electric machine, also according to the curve profile 23, the torque provided by the electric machine 3 is reduced, wherein the torque 24 at the driven end 5 is then maintained or made available due to the fact that, according to the curve profile 22, more torque is made available via the internal combustion engine 2 and, according to the curve profiles 25, 26, is transmitted via the separating clutch 7 toward the driven end 5. This takes place within permissible limits, i.e., depending on the presently maximally possible idling torque 27 of the internal combustion engine 2.

Example aspects of the invention also relate to a control unit for operating a hybrid vehicle, which is utilized for carrying out the above-described method according to example aspects of the invention on the control side. The control unit monitors the above-described rotational speeds and, depending thereon, actuates at least the separating clutch 7 in order to protect the internal combustion engine 2, in particular, against stalling. The control unit is, in particular, the hybrid control unit 11. The control unit includes components for carrying out the method according to example aspects of the invention, namely hardware-related components and software-related means. The hardware-related components include data interfaces for exchanging data with the assemblies contributing to the carrying-out of the method according to example aspects of the invention, such as with the separating clutch 7, the electric machine 3, and the engine control unit 10. The hardware-related components also encompass a processor for data processing and a memory for data storage. The software-related means include program components for carrying out the method according to example aspects of the invention.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE NUMBERS

1 prime mover
2 internal combustion engine
3 electric machine
4 transmission
5 driven end
6 electric accumulator
7 separating clutch
8 starting component
9 transmission control unit
10 engine control unit
11 hybrid control unit
20 rotational speed of internal combustion engine
21 rotational speed of electric machine
22 torque of internal combustion engine
23 torque of electric machine
24 torque of driven end
25 torque of separating clutch
26 pressure control of separating clutch
27 presently maximally possible idling torque of internal combustion engine
28 potential of internal combustion engine
29 maximally possible torque of electric machine

1-12. (canceled)

13. A method for operating a hybrid vehicle that includes a prime mover (1), a transmission (4), a separating clutch (7), and a starting component (8), the prime mover (1) including an internal combustion engine (2) and an electric machine (3), the transmission (4) including a plurality of shift elements, the transmission (4) connected between the prime mover (1) and a driven end (5), the separating clutch (7) connected between the internal combustion engine (2) and the electric machine (3), the starting component (8) provided either by a separate launch clutch or by at least one of the plurality of shift elements, the method comprising:
during travel with the internal combustion engine (2) running and the separating clutch (7) engaged, monitoring a rotational speed of one of more of the internal combustion engine (2), the electric machine (3), the transmission (4), and the driven end (5) in order to detect an increase in driving resistance; and
when the monitored rotational speed falls below or reaches a first limiting value (G3), partially disengaging the separating clutch (7) toward a disengagement position in which a torque transmitted by the separating clutch (7) is adjusted such that an idling speed controller of the internal combustion engine (2) accelerates the rotational speed of the internal combustion engine (2) toward an idling speed of the internal combustion engine (2).

14. The method of claim 13, further comprising determining the disengagement position of the separating clutch (7) based at least in part on a presently maximally possible idling torque of the internal combustion engine (2).

15. The method of claim 14, further comprising determining a pilot control component for the disengagement position of the separating clutch (7) based at least in part on the presently maximally possible idling torque of the internal combustion engine (2).

16. The method of claim 14, wherein determining the disengagement position of the separating clutch (7) comprises continuing to determine the disengagement position of the separating clutch (7) based at least in part on an idling torque of the internal combustion engine (2) presently demanded by the idling speed governor of the internal combustion engine (2) such that the torque transmitted by the separating clutch (7) in the disengagement position corresponds to a difference between the presently maximally possible idling torque and the idling torque presently demanded by the idling speed governor of the internal combustion engine (2) minus an offset.

17. The method of claim 16, further comprising determining the offset based at least in part on a temperature-dependent drag torque of the separating clutch (7).

18. The method of claim 13, wherein determining the disengagement position of the separating clutch (7) comprises continuing to determine the disengagement position of the separating clutch (7) based at least in part on a maximally permitted idling torque of the idling speed governor of the internal combustion engine (2) such that the torque transmitted by the separating clutch (7) in the disengagement position corresponds to a difference between the presently maximally possible idling torque and the maximally permitted idling torque of the idling speed governor minus an offset.

19. The method of claim 18, further comprising determining the offset based at least in part on a temperature-dependent drag torque of the separating clutch (7).

20. The method of claim 15, further comprising superimposing a governor component on the pilot control component, and determining the governor component based at least in part on a developing actual rotational speed of the internal combustion engine (2) and the idling speed of the internal combustion engine (2).

21. The method of claim 13, further comprising determining the first limiting value (G3) of the monitored rotational speed based at least in part on one or more of a gradient with respect to time of the reduction of the monitored speed, a temperature of the separating clutch (7), a transmission oil temperature, and a charge state of an electric accumulator (6) from which the electric machine (3) is supplied with electrical energy.

22. The method of claim 13, wherein the method is carried out while a gas pedal of the hybrid vehicle is actuated and a brake pedal of the hybrid vehicle is not actuated.

23. The method of claim 13, further comprising subsequently reengaging the separating clutch (7) when both the rotational speed of the internal combustion engine (2) and the rotational speed of the electric machine (3) exceed a second limiting value (G5), wherein the second limiting value (G5) is greater than the first limiting value (G3).

24. A control unit for operating a hybrid vehicle that includes a prime mover (1), a transmission (4), a separating clutch (7), and a starting component (8), the prime mover (1) including an internal combustion engine (2) and an electric machine (3), the transmission (4) including a plurality of shift elements, the transmission (4) connected between the prime mover (1) and a driven end (5), the separating clutch (7) connected between the internal combustion engine (2) and the electric machine (3), the starting component (8) provided either by a separate launch clutch or by at least one of the plurality of shift elements, the control unit configured for:
during travel with the internal combustion engine (2) running and the separating clutch (7) engaged, monitoring a rotational speed of one of more of the internal combustion engine (2), the electric machine (3), the transmission (4), and the driven end (5) in order to detect an increase in driving resistance; and
when the monitored rotational speed falls below or reaches a first limiting value (G3), partially disengaging the separating clutch (7) toward a disengagement position in which a torque transmitted by the separating clutch (7) is adjusted such that an idling speed controller of the internal combustion engine (2) accelerates the rotational speed of the internal combustion engine (2) toward an idling speed of the internal combustion engine (2).

25. A control unit configured to implement the method of claim 13 on a control side.
